(19) United States
(12) Patent Application Publication
(10) Pub. No.: US 2023/0155988 A1
(43) Pub. Date: May 18, 2023

(54) PACKET SECURITY OVER MULTIPLE NETWORKS

(71) Applicant: Intel Corporation, Santa Clara, CA (US)

(72) Inventors: Surekha PERI, Austin, TX (US); Helia A. NAEIMI, Santa Clara, CA (US); Anurag AGRAWAL, Santa Clara, CA (US)

(21) Appl. No.: 18/099,795

(22) Filed: Jan. 20, 2023

(51) Int. Cl. H04L 9/40

(52) U.S. Cl. CPC H04L 63/0485; H04L 63/0478; H04L 63/0272

(57) ABSTRACT

Examples described herein relate to a network interface device that includes an interface and circuitry. In some examples, the circuitry coupled to the interface is to apply encryption for packets received from a first network interface device and tunnel the encrypted packets to a second network interface device. In some examples, forwarding operations by the first network interface device and forwarding operations in the second network interface device are based on different header fields.

### BACKGROUND

Open Systems Interconnection (OSI) Layer 2 (L2) networks can utilize switches that process Ethernet header field values to determine how to forward packets to another switch or endpoint. Latency sensitive distributed applications can be deployed over layer 2 networks as they can meet delay requirements of Service Level Assurances or Agreements (SLAs). Media Access Control Security (MACsec) is a security technology that provides point-to-point security on Ethernet links between nodes and end-to-end (EtE) security for Ethernet stations across layer 2 networks with hop-by-hop extensions in a wide area network (WAN) to provide integrity and confidentiality of transmitted data.

MACsec is defined at least by Institute of Electrical and Electronics Engineers (IEEE) standard 802.1AE-2018 and provides for authentication and encryption of Ethernet frames for point-to-point security on Ethernet links. Subsequent amendments to IEEE 802.1AE-2018 include enhancements specifying Ethernet Data Encryption devices (EDEs) that provide transparent secure connectivity across WANs, and co-existence with provider network service selection and provider backbone network selection as specified in IEEE standard 802.1Q-2018.

### BRIEF DESCRIPTION OF THE DRAWINGS

FIG. 1 depicts an example system.

FIG. 2 depicts example deployments.

FIG. 3A depicts an example system.

FIG. 3B depicts an example system.

FIG. 4 depicts an example system.

FIG. 5 depicts an example of packet formats.

FIG. 6 depicts an example process.

FIG. 7 depicts an example system.

FIG. 8 depicts an example system.

### DETAILED DESCRIPTION

OSI layer 3 can include a Network Layer with a path controlled by Internet Protocol (IP) version X technologies, where X is an integer. Layer 3 (L3) networks can utilize switches or routers that process IP header field values to determine how to forward packets to another multi-layer switch or router, or endpoint. Cloud computing and flexible network element placement can lead to deployment of distributed applications over layer 2 and/or layer 3 networks. In some cases, applications utilize network packet security over a combination of layer 2 and layer 3 networks. However, some switches support encryption for communications using layer 2 networks (e.g., MACsec) and not encryption for communications using layer 3 networks (e.g., Internet Protocol Security (IPsec)).

In some examples, multi-homed network interface devices can be connected to both layer 2 and layer 3 networks to provide layer 2 network security over a layer 3 network, without the need for an additional layer 3 cryptographic circuitry and accompanying cost increase, power increase, and increase in use of silicon space. In some examples, a network can include one or more switches and/or routers (e.g., one or more hops) and provide communications between endpoint devices such as servers or host computers. In some examples, in a network interface device, per physical port, circuitry that can perform MACsec encryption and decryption operations can tunnel packets protected using MACsec using an layer 3 network in an Ethernet Data Encryption-Tunnel mode (EDE-T). For example, at ingress, the circuitry that performs MACsec encryption and decryption operations can apply MACsec decryption or, at egress, MACsec encryption followed by Layer 3 tunneling. For example, MACsec security may be extended over Layer 3 networks by tunneling MACsec encrypted packets over Layer 3 overlays, e.g., Virtual Extensible LAN (VXLAN or VxLAN). In some examples, network interface devices can be used in fronthaul and/or sidehaul RAN that provide support for secure layer 3 connectivity in 6G equipment.

For example, for L3 VPN origination of an outbound packet, a switch can perform one or more of: security association (SA) identification on an Ethernet frame, packet encryption, append an L3 VPN header, access an L3 forwarding database to determine next hop or next network interface device to receive the packet, and send the packet in an external network to another switch, router, or endpoint. For example, for forwarding a packet tunneled using L3 L3VPN, the switch can perform one or more of: decapsulate a payload, perform SA identification, decrypt the packet, perform encryption of the packet, and tunnel the packet using a same or different L3 VPN to another switch, router, or endpoint. For example, for L3 L3VPN termination of an inbound packet, the switch can perform one or more of: decapsulate a payload, perform SA identification, decrypt the packet and transmit the decrypted packet to an endpoint (e.g., server or host). An outbound tunnel may be identified by incoming <physical interface, VLAN ID> and an SA may be identified by L3 VPN interface id, <Physical interface, [VID]>, and/or other parameters.

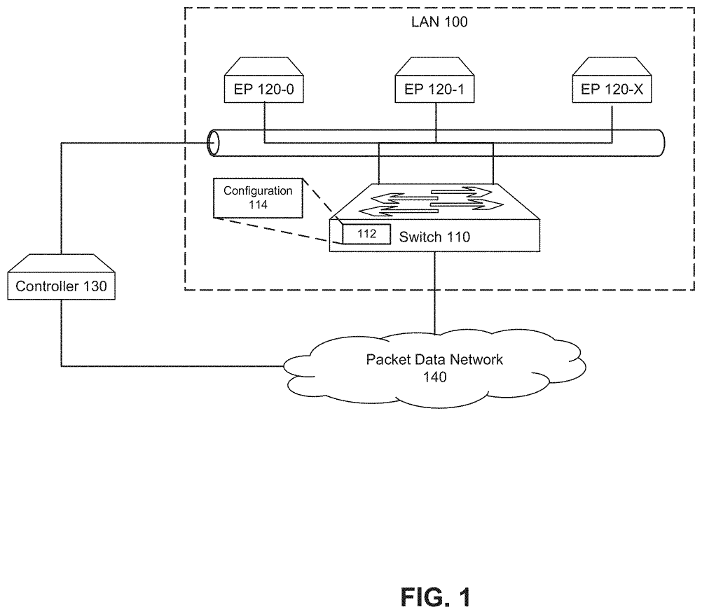

FIG. 1 depicts an example system. In local area network (LAN) 100, switch 110 can provide communications among multiple endpoint (EP) devices 120-0 to 120-X, where X is an integer, using LAN 100. EP devices can include one or more of: network interface devices connected to servers, storage devices, memory pools, accelerators, or a combination thereof. For example, communications in LAN 100 can be based on Ethernet (e.g., IEEE 802.3) or other protocols.

In some examples, EPs 120-0 to 120-X can be part of RAN nodes. A RAN node can include multiple processing elements, such as digital signal processors (DSPs) and multi-core processors connected over a secure backplane with protected external cross haul (Xhaul) connectivity. Xhaul connectivity can include network connectivity to RAN that includes backhaul, midhaul, sidehaul, and/or fronthaul.

As described herein, switch 120 can utilize circuitry 112 to extend encrypted communications over networks that forward packets based on different criteria. For example, where switch 110 forwards packets in an L2 network based on one or more Ethernet header field values, circuitry 112 can encrypt packet content (e.g., header and/or payload). In some examples, encryption applied can include MACsec, although others can be used such as Virtual Desktop Infrastructure (VDI), VMware Software-Defined Wide Area Network (SD-WAN), or others. For example, where switch 110 forwards packets from a network element or endpoint in or connected to an L2 network to a network element or endpoint in or connected to an L3 network based on one or more IP header field values, circuitry 112 can tunnel encrypted packets using a virtual private network (VPN). For example, where switch 110 forwards packets from a network element or endpoint in or connected to an L3 network to a network element or endpoint in or connected to an L3 network based on one or more IP header field values, circuitry 112 can encrypt packet content (e.g., header and/or payload). In some examples, encryption applied can include IPsec, although others can be used, such as NordVPN, OpenVPN Access Server, NetMotion, pfSense, ProtonVPN, Perimeter 81, ExpressVPN, Windscribe, or others.

In some examples, controller 130 can configure switch 110 as to whether an L2 switch or an L3 router is an intermediary between switches to identify whether switch is connected to an L2 or L3 network. In some examples, controller 130 can configure operation of circuitry 112 with a configuration 114 transmitted in one or more packets (e.g., control packets) via a network, via an application program interface (API), or through a device interface (e.g., Peripheral Component Interconnect express (PCIe), Compute Express Link (CXL), or others). Controller 130 can be implemented as a software-defined networking (SDN) controller that executes on a server or host system or other controller. For example, configuration 114 can specify whether switch 110 is coupled to receive packets, of a particular flow, from an L2 network or packets, of a particular flow, from an L3 network and whether switch 110 is to transmit packets, of a particular flow, to an L2 network or to an L3 network. For example, configuration 114 can specify a type of encryption that circuitry 112 is to apply and a type of tunneling that circuitry 112 is to perform. Configuration 114 can specify SAs for one or more packets. Packets received from an L2 or L3 network or to be transmitted to an L2 or L3 network can be identified by a flow or tunnel identifier. A type of encryption that circuitry 112 is to perform and a type of tunneling that circuitry 112 is to perform can be specified per flow or tunnel.

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

Reference to a flow can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

For example, a control stack executing on a host system connected to switch 110 (e.g., controller 130 or other server) can utilize clear text addresses in connectivity establishments, such as a certificate authority (CA), key exchanges for configuration of encryption and decryption operations in a manner consistent at least with the IEEE 802.1AE MACsec (2006) standard and IEEE 802.1X-2010, as well as variations, revisions, or derivatives thereof.

In some examples, for MACsec deployments over layer 2 networks, end points can employ application segmentation or IP fragmentation or others. In some examples, a switch control stack executed by controller 130 can propagate a change on the external link, route, path maximum transmission unit (MTU) sizes to the end points for use as MTU segmentation or packetization by the end point.

While examples are described with respect to an Ethernet End station, features are applicable to a clear text IP end host as well. Examples can be utilized with application-layer cryptographic schemes such as apply alternatively or in addition to network security protocols at higher layers such as Datagram Transport Layer Security (DTLS) or TLS.

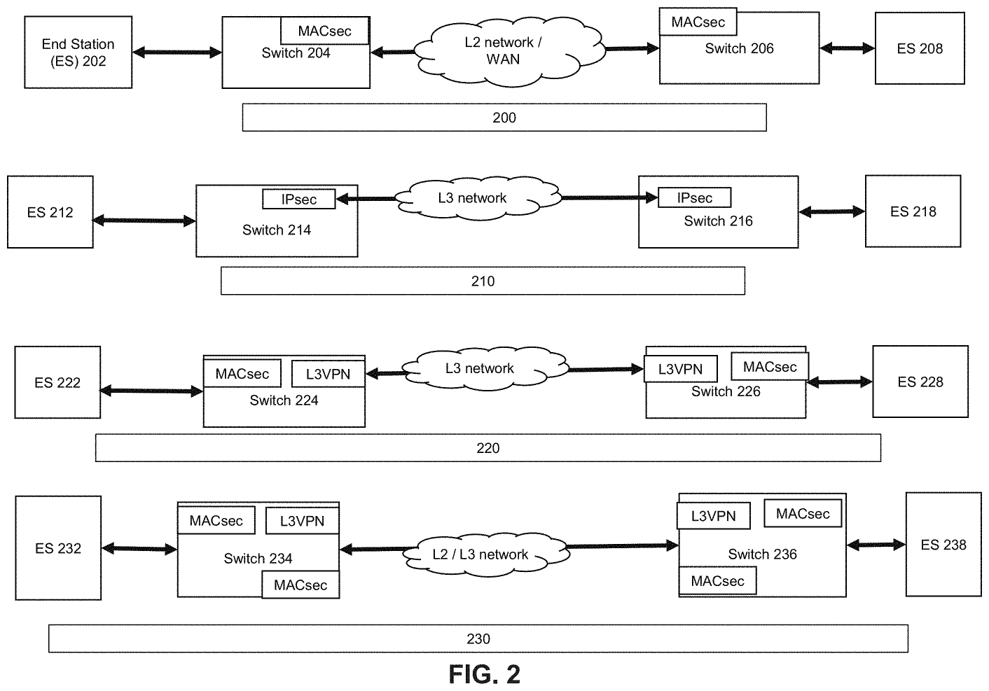

FIG. 2 depicts examples of utilization of switches among layer 2 and layer 3 networks. For example, switches (e.g., central switching gateways) can include circuitry to decrypt packets encrypted with MACsec tunneled using a layer 3 network or encrypt packets with MACsec and tunnel encrypted packets over layer 3 networks.

For example, in configuration 200, an end station (ES) 202 can transmit unencrypted (e.g., clear text) packets (e.g., one or more header fields and/or payload) to switch 204. Switch 204 can encrypt and transmit MACsec encrypted packets using a public and/or private L2 network to switch 206. Switch 206 can decrypt MACsec encrypted packets and provide unencrypted packets (e.g., one or more unencrypted header fields and/or unencrypted payload or MSDU) to ES 208. For L2 packet forwarding, termination, or origination, switches 204 and 206 can perform MACsec encryption and decryption. When MACsec is enabled, MACsec circuitry of switch 204 may not perform header packet processing prior to the encryption.

For example, in configuration 210, an ES 212 can transmit unencrypted packets to switch 214. Switch 214 can encrypt and transmit IPsec encrypted packets using a public and/or private L3 network to switch 216. Switch 216 can decrypt IPsec encrypted packets and provide unencrypted packets to ES 218. For example, a network can be classified as L3 if an L3 switch is present in the network even if other devices are L2 switches.

For example, in configuration 220, an ES 222 can transmit unencrypted packets to switch 224. Switch 224 can encrypt and transmit MACsec encrypted packets and tunnel MACsec encrypted packets over a public and/or private L3 network using a virtual private network (VPN) to switch 226. Switch 226 can receive MACsec encrypted packets tunneled using a VPN and decrypt MACsec encrypted packets and provide unencrypted packets to ES 228.

For example, in configuration 230, an ES 232 can transmit unencrypted packets to switch 234. For packets transmitted over a public and/or private L2 network, switch 234 can encrypt and transmit MACsec encrypted packets using a public and/or private L2 network to switch 236. Switch 236 can decrypt MACsec encrypted packets and provide unencrypted packets to ES 238.

For example, in configuration 230, for packets transmitted over a public and/or private L3 network, switch 234 can encrypt and transmit MACsec encrypted packets and tunnel MACsec encrypted packets over a public and/or private L3 network using a VPN to switch 236. Switch 234 can receive MACsec encrypted packets via L3 tunneling protocol (e.g., a VPN) and decrypt MACsec encrypted packets and provide unencrypted packets to ES 238. An L3 VPN can utilize an L3 network to tunnel L2 traffic. For example, Virtual Extensible Local Area Network (VXLAN) can extend a virtual local area network (VLAN) over IP network to tunnel MACsec Ethernet frames. In an EDE-T (tunnel) mode, MACsec circuitry of switch 234 can apply entry/exit points for MACsec Protocol Data Unit (MPDU) and MACsec Service Data Unit (MSDU) and packet header classification to control data rate. Alternatives to VxLAN can include Generic Routing Encapsulation (GRE), Network Virtualization using Generic Routing Encapsulation (NVGRE), Overlay Transport Virtualization (OTV), Layer 2 Tunnelling Protocol version 3, MPLS, or others.

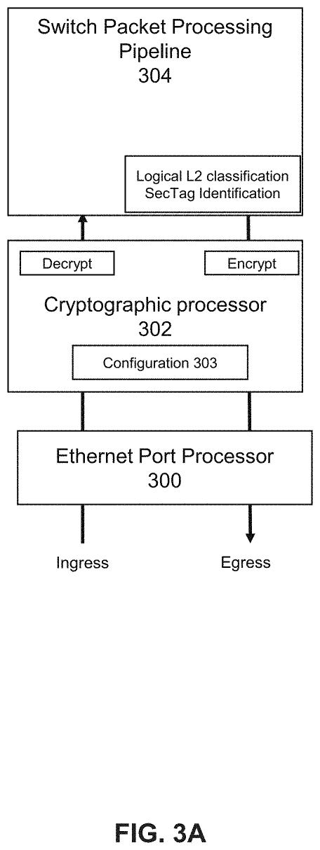

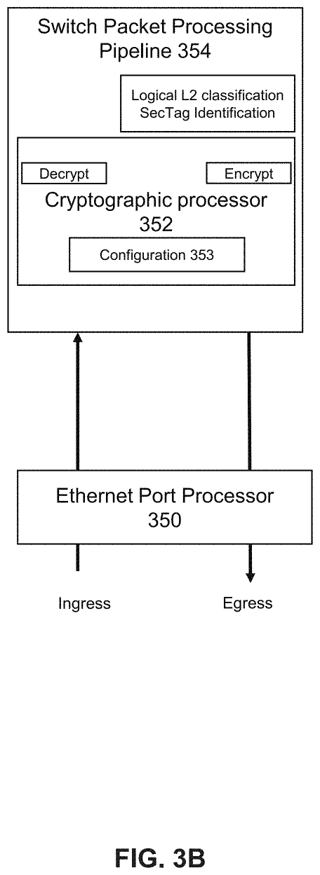

FIG. 3A depicts an example system. For ingress packets (e.g., packet received from a network), circuitry of Ethernet port processor 300 can perform packet processing and decapsulation in accordance with applicable protocols (e.g., Ethernet) as well as perform the routing of data packets based on IP addresses. In some examples, cryptographic processor 302 can perform MACsec decryption and encryption operations for one or more physical ingress ports and/or physical egress ports. In some examples, cryptographic processor 302 can perform MACsec decryption and encryption operations for a single physical port. For ingress packets, based on a configuration 303, cryptographic processor 302 can perform one or more of: decapsulation of packets transmitted using a tunnel such as a VPN, security tag classification to identify an SA based on an L3 VPN interface ID associated with the VxLAN or other L3 VPN, SA identification for use to decrypt the received packet, and/or decryption of ingress packets (e.g., decryption of one or more header fields and/or payload) based on identified SA. An SA can include one or more encryption keys identified by an association number. A packet number can be associated with a security association. For packet ingress, the packet number from the MACsec header can be checked against the packet number stored in the corresponding secure association to perform replay protection.

However, the MACsec scale is at L2 layer network and can support a limited number of SAs. Of a set of L3 VPN interface IDs, a subset number of L3 VPN interface IDs can be utilized for an SA Index and can be valid, whereas other values can be invalid.

Switch packet processing pipeline 304 can receive decrypted packets (e.g., clear text packets) and perform L2 classification such as packet header classification to control data rate. Switch packet processing pipeline 304 can perform security tag identification to identify a security association for the packet. Switch packet processing pipeline 304 can include a programmable processing pipeline or offload circuitries that is programmable by configuration 303. Switch packet processing pipeline 304 can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow. Switch packet processing pipeline 304 can include one or more match-action units (MAUs) that are configured based on a programmable pipeline language instruction set. Processors, field programmable gate arrays (FPGAs), other specialized processors, controllers, devices, and/or circuits can be used utilized for packet processing or packet modification. Ternary content-addressable memory (TCAM) can be used for parallel match-action or look-up operations on packet header content.

For egress packets (e.g., packets to be transmitted to a network element or endpoint), switch packet processing pipeline 304 can perform L2 classification such as packet header classification to control data rate and perform security tag identification to identify a security association for the packet. For egress packets, based on a configuration 303 and identified SA, cryptographic processor 302 can perform encryption of packets based on identified SA (e.g., MACsec) and encapsulation of packets transmitted using a tunnel such as a VPN. For packet egress, a packet number can be written in a MACsec header and used in packet encryption.

FIG. 3B depicts an example system. Switch packet processing pipeline 354 can be configured to perform operations of cryptographic processor 352 for one or more physical or logical ingress ports and/or physical or logical egress ports. A logical port can represent a classification of one or more ports or a sub-port. Operations of cryptographic processor 352 can be configured based on configurations 353. For example, for ingress packets, operations of cryptographic processor 352 can include one or more of: decapsulation of packets transmitted using a tunnel such as a VPN, security tag classification to identify an SA based on an L3 VPN interface ID associated with the VxLAN or other L3 VPN, SA identification for use to decrypt the received packet, and/or decryption of ingress packets (e.g., decryption of one or more header fields and/or payload) based on identified SA.

For example, for egress packets, switch packet processing pipeline 304 can perform one or more of: L2 classification such as packet header classification to control data rate and perform security tag identification for an SA. For egress packets, based on a configuration 353 and identified SA, operations of cryptographic processor 352 can include encryption of packets based on identified SA and encapsulation of packets transmitted using a tunnel such as a VPN. For example, for egress packets, operations of cryptographic processor 352 can include packet encryption (e.g., encryption of one or more clear text header fields and/or clear text payload). In EDE-T mode, MACsec circuitry can encrypt a packet and encapsulate the encrypted packet for transmission in an L3 VPN (e.g., VxLAN) or other VPN based on configuration 353.

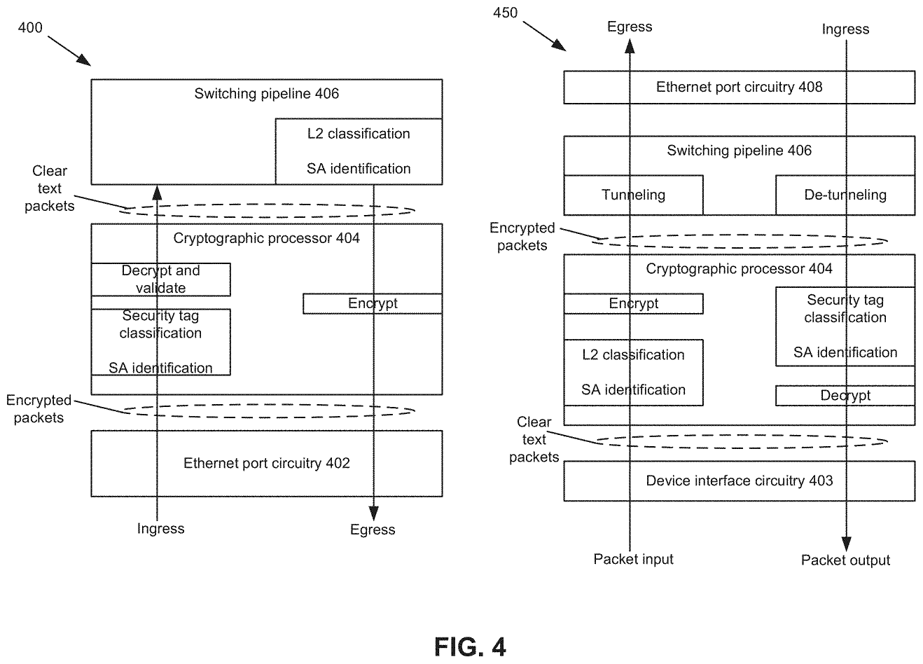

FIG. 4 depicts an example system. Ethernet port 402 can operate in at least two modes. In mode 400, for ingress packets, Ethernet port 402 can be configured to provide encrypted packets, at ingress to cryptographic processor 404 for decryption based on associated SAs, as described herein. For example, packets can be decrypted based on MACsec or other protocols. Cryptographic processor 404 can provide unencrypted packets (e.g., one or more unencrypted header fields and/or unencrypted payload or MSDU) to switching pipeline 406.

In mode 400, for egress packets, switching pipeline 406 can perform packet classification and switching pipeline 406 can identify an SA for unencrypted packets to cryptographic processor 404. Cryptographic processor 404 can encrypt the packets (e.g., MPDU) prior to transmission by Ethernet port 402 to another network device or endpoint.

In mode 450, for packets to be forwarded to another network interface device, device interface circuitry 403 (e.g., PCIe, CXL, or other interface) can provide unencrypted packets (e.g., one or more unencrypted header fields and/or unencrypted payload or MSDU) to cryptographic processor 404. Input packets can be provided to device interface circuitry 403 by a host or server or Ethernet end point inside a LAN, in some examples. Cryptographic processor 404 can encrypt packets based on associated SA and provide encrypted packets (e.g., MPDU) to switching pipeline 406. Switching pipeline 406 can process encrypted packets for tunneling (e.g., L3VPN encapsulation specified by a configuration). Switching pipeline 406 can provide the tunneled encrypted packets for forwarding via Ethernet port circuitry 408 to another network interface device or endpoint.

In mode 450, Ethernet port circuitry 408 can provide received encrypted packets (e.g., MDPU) to switching pipeline 406. Switching pipeline 406 can process encrypted packets by performing de-tunneling (e.g., L3VPN de-encapsulation specified by a configuration). Cryptographic processor 404 can perform decryption based on an applicable SA and provide the unencrypted packets (e.g., one or more unencrypted header fields and/or unencrypted payload or MSDU) to an Ethernet end point via device interface circuitry 403 to a host or server or Ethernet end point inside a LAN, in some examples.

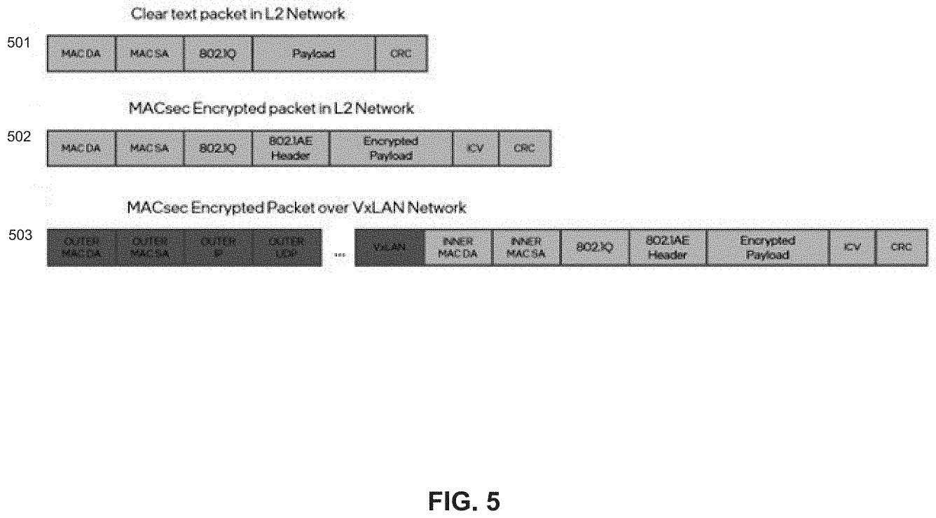

FIG. 5 depicts an example of packet formats. For example, configuration 501 can represent fields of a clear text packet. A clear text packets can include a media access control (MAC) destination address (DA), MAC sender address (SA), one or more IEEE 802.1Q fields, payload, and cyclic redundancy check (CRC) fields.

For example, configuration 502 can represent fields of a MACsec encrypted packet. A MACsec encrypted packet can include MAC DA, MAC SA, one or more IEEE 802.1Q fields, IEEE 802.1AE header, encrypted payload, Integrity Check Value (ICV), and CRC.

For example, configuration 503 can represent fields of a MACsec encrypted packet within a tunnel. A MACsec encrypted packet within a tunnel can include outer MAC DA, outer MAC SA, outer IP address, outer User Datagram Protocol (UDP) address, VxLAN identifier, inner MAC DA, inner MAC SA, one or more IEEE 802.1Q fields, IEEE 802.1AE header, encrypted payload, Integrity Check Value (ICV), and CRC.

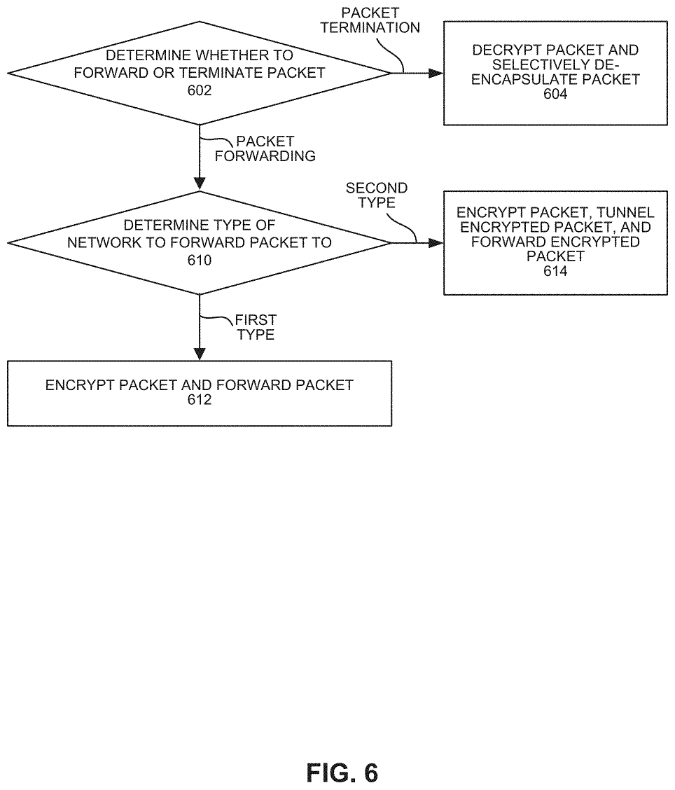

FIG. 6 depicts an example process. The process can be performed by a network interface device, in some examples. In some examples, the process can be performed by a switch to forward packets based on Ethernet and/or IP packet header fields, or other protocols. At 602, based on receipt of a packet, a determination of whether a forwarding operation or termination operation can be made. Based on the packet being forwarded, action 610 can follow action 602. Based on the packet being terminated, action 604 can follow action 602. At 604, based on the packet being received from a tunnel or virtual private network, the packet can be de-encapsulated, decrypted, and provided to an endpoint node (e.g., host or server).

At 610, a determination can be made of a network type to which to forward the packet. Based on one or more Ethernet packet header fields being used to make a packet forwarding decision and the network from which the packet was received also made forwarding decisions based on one or more Ethernet packet header fields, the network type can be identified as a first type and action 612 can follow. Based on one or more IP packet header fields being used to make a packet forwarding decision and the network from which the packet was received made forwarding decisions based on one or more Ethernet packet header fields, the network type can be identified as a second type and action 614 can follow. In some examples, forwarding decisions in a first type of network, from which the packet was received, can be made based on different header fields than forwarding decisions in a second type of network, to which the packet is to be transmitted.

At 612, encryption of the packet and forwarding of the packet to a next device can be performed. In some examples, the encryption can utilize MACsec, although other encryption schemes can be used.

At 614, encryption of the packet, tunneling of the encrypted packet, and forwarding of the packet to a next device can be performed. In some examples, the encryption can utilize MACsec, although other encryption schemes can be used. In some examples, tunneling can utilize a VPN such as VxLAN, although other tunnels can be used.

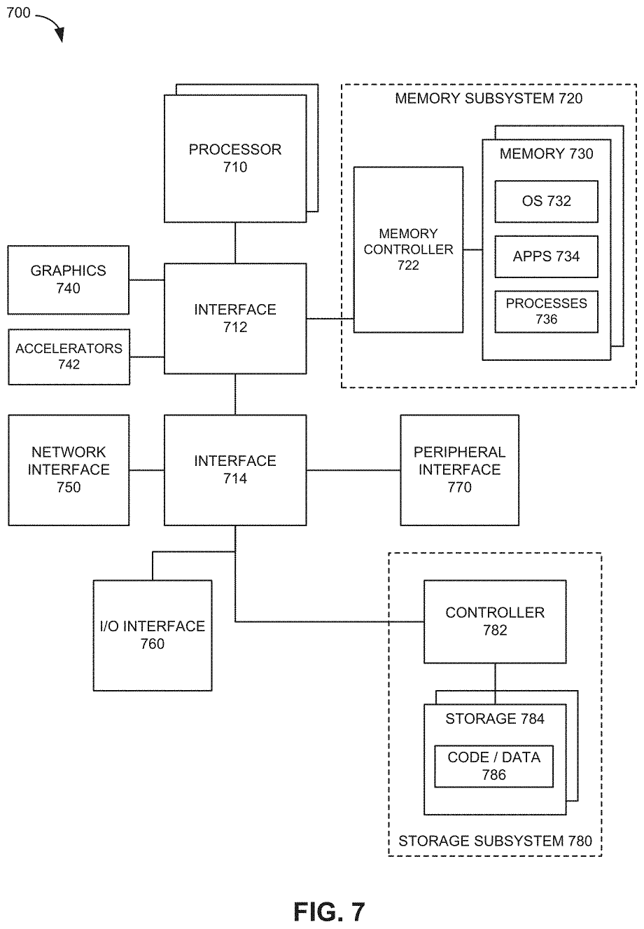

FIG. 7 depicts an example computing system. Components of system 700 (e.g., processor 710, accelerators 742, network interface 750, memory subsystem 720, and so forth) can be configured to tunnel encrypted packets through multiple networks or decrypt tunneled packets through multiple networks, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Network interface 750 can include one or more of: a network interface controller (NIC), a remote direct memory access (RDMA)-enabled NIC, SmartNIC, router, switch, or network-attached appliance. Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU.

For example, network interface 750 can include Media Access Control (MAC) circuitry, a reconciliation sublayer circuitry, and physical layer interface (PHY) circuitry. The PHY circuitry can include a physical medium attachment (PMA) sublayer circuitry, Physical Medium Dependent (PMD) circuitry, a forward error correction (FEC) circuitry, and a physical coding sublayer (PCS) circuitry. In some examples, the PHY can provide an interface that includes or use a serializer de-serializer (SerDes). In some examples, at least where network interface 750 is a router or switch, the router or switch can include interface circuitry that includes a SerDes.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. A volatile memory is memory whose state (and therefore the data stored in it) is indeterminate if power is interrupted to the device. A non-volatile memory (NVM) device is a memory whose state is determinate even if power is interrupted to the device. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) (e.g., NVMe-oF specification, version 1.0 (2016) as well as variations, extensions, and derivatives thereof) or NVMe (e.g., Non-Volatile Memory Express (NVMe) Specification, revision 1.3c, published on May 24, 2018 (“NVMe specification”) as well as variations, extensions, and derivatives thereof).

Communications between devices can take place using a network that provides die-to-die communications; chip-to-chip communications; circuit board-to-circuit board communications; and/or package-to-package communications.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, cloud and software-defined networking to deliver application workloads across physical data centers and distributed multi-cloud environments).

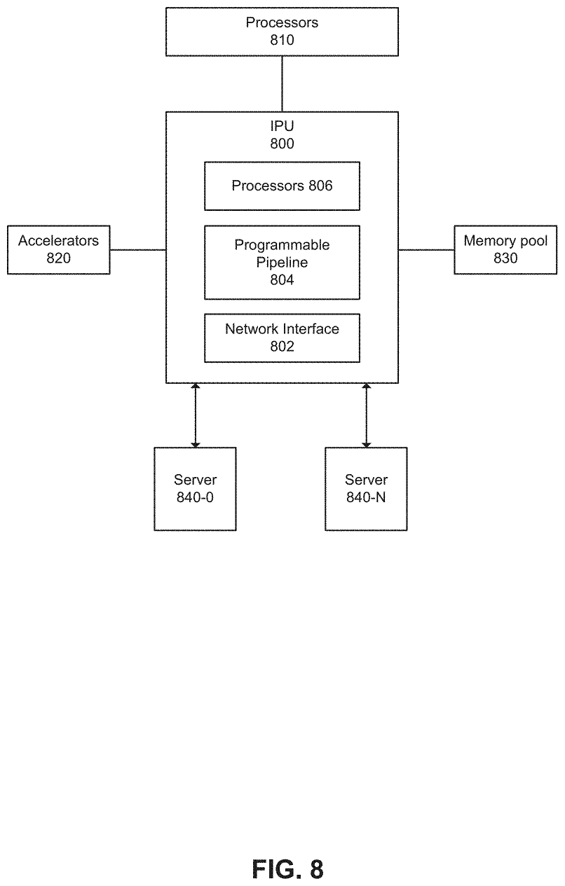

FIG. 8 depicts an example network interface device. Network interface device 800 manages performance of one or more processes using one or more of processors 806, processors 810, accelerators 820, memory pool 830, or servers 840-0 to 840-N, where N is an integer of 1 or more. In some examples, processors 806 of network interface device 800 can execute one or more processes, applications, VMs, containers, microservices, and so forth that request performance of workloads by one or more of: processors 810, accelerators 820, memory pool 830, and/or servers 840-0 to 840-N. Network interface device 800 can utilize network interface 802 or one or more device interfaces to communicate with processors 810, accelerators 820, memory pool 830, and/or servers 840-0 to 840-N. Network interface device 800 can utilize programmable pipeline 804 to process packets that are to be transmitted from network interface 802 or packets received from network interface 802.

Programmable pipeline 804 and/or processors 806 can be configured or programmed using languages based on one or more of: P4, Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86 compatible executable binaries or other executable binaries. Programmable pipeline 804, processors 806, and/or memory pool 830 can be configured to tunnel encrypted packets through multiple networks or decrypt tunneled packets through multiple networks, as described herein.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: a network interface device comprising: an interface and circuitry coupled to the interface to apply encryption for packets received from a first network interface device and tunnel the encrypted packets to a second network interface device, wherein forwarding operations by the first network interface device and forwarding operations in the second network interface device are based on different header fields.

Example 2 includes one or more examples, wherein the encryption comprises Media Access Control Security (MACsec).

Example 3 includes one or more examples, wherein the encryption comprises Media Access Control Security (MACsec) and wherein the tunnel the encrypted packets to the second network interface device comprises provide security for the encrypted packets sent to the second network interface device without utilization of Internet Protocol Security (IPsec).

Example 4 includes one or more examples, wherein the tunnel the encrypted packets to the second network interface device comprises utilize a virtual private network for the encrypted packets.

Example 5 includes one or more examples, wherein the tunnel the encrypted packets to the second network interface device comprises utilize a Virtual Extensible LAN (VXLAN).

Example 6 includes one or more examples, wherein the forwarding operations by the first network interface device are based on at least one Ethernet header field and forwarding operations by the second network interface device are based on at least one Internet Protocol (IP) header field.

Example 7 includes one or more examples, wherein based on forwarding operations by the first network interface device and forwarding operations by the second network interface device being based on at least one same header field, the circuitry is to apply the encryption for packets received from the first network interface device and prior to transmission to the second network interface device.

Example 8 includes one or more examples, wherein based on forwarding of a first packet of the packets received from the first network interface device, the circuitry is configured to decapsulate the first packet, identify a security association (SA), and decrypt the first packet based on the SA.

Example 9 includes one or more examples, wherein the circuitry comprises a packet processing pipeline comprising a parser and at least one configurable match-action circuitry.

Example 10 includes one or more examples, wherein the circuitry comprises an accelerator and wherein the network interface device comprises a packet processing pipeline communicatively coupled to the accelerator and wherein the packet processing pipeline comprises a parser and at least one configurable match-action circuitry.

Example 11 includes one or more examples, and includes a method comprising: in a datacenter comprising first and second networks: a switch selecting packet processing operations based on forwarding operations in the first network and forwarding operations in the second network, wherein: based on the forwarding operations in the first network and forwarding operations in the second network being based on different header fields, applying encryption for packets received from the first network and tunneling the encrypted packets over the second network prior to forwarding the packets and based on the forwarding operations in the first network and forwarding operations in the second network not being based on different header fields, applying encryption for packets received from the first network prior to forwarding the packets.

Example 12 includes one or more examples, wherein the encryption comprises Media Access Control Security (MACsec).

Example 13 includes one or more examples, wherein the encryption comprises Media Access Control Security (MACsec) and wherein the tunnel the encrypted packets over the second network comprises provide security for the encrypted packets over the second network without utilization of Internet Protocol Security (IPsec).

Example 14 includes one or more examples, wherein the tunneling the encrypted packets over the second network comprises utilizes a virtual private network for the encrypted packets.

Example 15 includes one or more examples, wherein the forwarding operations in the first network are based on at least one Ethernet header field and forwarding operations in the second network are based on at least one Internet Protocol (IP) header field.

Example 16 includes one or more examples, and includes a non-transitory computer-readable medium comprising instructions stored thereon, that if executed by one or more processors, cause the one or more processors to: configure circuitry of a switch to select a mode of operation based on forwarding operations in a first network and forwarding operations in a second network, wherein the switch is coupled to the first and second networks, wherein: based on the forwarding operations in the first network and forwarding operations in the second network being based on different header fields, the circuitry is configured to apply encryption for packets received from the first network and tunnel the encrypted packets over the second network prior to forwarding the packets and based on the forwarding operations in the first network and forwarding operations in the second network not being based on different header fields, the circuitry is configured to apply encryption for packets received from the first network prior to forwarding the packets.

Example 17 includes one or more examples, wherein the encryption comprises Media Access Control Security (MACsec).

Example 18 includes one or more examples, wherein the encryption comprises Media Access Control Security (MACsec) and wherein the tunnel the encrypted packets over the second network comprises provide security for the encrypted packets over the second network without utilization of Internet Protocol Security (IPsec).

Example 19 includes one or more examples, wherein the tunnel the encrypted packets over the second network comprises utilize a virtual private network for the encrypted packets.

Example 20 includes one or more examples, wherein the tunnel the encrypted packets over the second network comprises tunnel the encrypted packets over the second network comprises utilize a Virtual Extensible LAN (VXLAN).

What is claimed is:

1. An apparatus comprising:
a network interface device comprising:
an interface and
circuitry coupled to the interface to apply encryption for packets received from a first network interface device and tunnel the encrypted packets to a second network interface device, wherein forwarding operations by the first network interface device and forwarding operations in the second network interface device are based on different header fields.

2. The apparatus of claim 1, wherein the encryption comprises Media Access Control Security (MACsec).

3. The apparatus of claim 1, wherein the encryption comprises Media Access Control Security (MACsec) and wherein the tunnel the encrypted packets to the second network interface device comprises provide security for the encrypted packets sent to the second network interface device without utilization of Internet Protocol Security (IPsec).

4. The apparatus of claim 1, wherein the tunnel the encrypted packets to the second network interface device comprises utilize a virtual private network for the encrypted packets.

5. The apparatus of claim 1, wherein the tunnel the encrypted packets to the second network interface device comprises utilize a Virtual Extensible LAN (VXLAN).

6. The apparatus of claim 1, wherein the forwarding operations by the first network interface device are based on at least one Ethernet header field and forwarding operations by the second network interface device are based on at least one Internet Protocol (IP) header field.

7. The apparatus of claim 1, wherein based on forwarding operations by the first network interface device and forwarding operations by the second network interface device being based on at least one same header field, the circuitry is to apply the encryption for packets received from the first network interface device and prior to transmission to the second network interface device.

8. The apparatus of claim 1, wherein based on forwarding of a first packet of the packets received from the first network interface device, the circuitry is configured to decapsulate the first packet, identify a security association (SA), and decrypt the first packet based on the SA.

9. The apparatus of claim 1, wherein the circuitry comprises a packet processing pipeline comprising a parser and at least one configurable match-action circuitry.

10. The apparatus of claim 1, wherein the circuitry comprises an accelerator and wherein the network interface device comprises a packet processing pipeline communicatively coupled to the accelerator and wherein the packet processing pipeline comprises a parser and at least one configurable match-action circuitry.

11. A method comprising:
in a datacenter comprising first and second networks:
a switch selecting packet processing operations based on forwarding operations in the first network and forwarding operations in the second network, wherein:
based on the forwarding operations in the first network and forwarding operations in the second network being based on different header fields, applying encryption for packets received from the first network and tunneling the encrypted packets over the second network prior to forwarding the packets and
based on the forwarding operations in the first network and forwarding operations in the second network not being based on different header fields, applying encryption for packets received from the first network prior to forwarding the packets.

12. The method of claim 11, wherein the encryption comprises Media Access Control Security (MACsec).

13. The method of claim 11, wherein the encryption comprises Media Access Control Security (MACsec) and wherein the tunnel the encrypted packets over the second network comprises provide security for the encrypted packets over the second network without utilization of Internet Protocol Security (IPsec).

14. The method of claim 11, wherein the tunneling the encrypted packets over the second network comprises utilizes a virtual private network for the encrypted packets.

15. The method of claim 11, wherein the forwarding operations in the first network are based on at least one Ethernet header field and forwarding operations in the second network are based on at least one Internet Protocol (IP) header field.

16. A non-transitory computer-readable medium comprising instructions stored thereon, that if executed by one or more processors, cause the one or more processors to:
configure circuitry of a switch to select a mode of operation based on forwarding operations in a first network and forwarding operations in a second network, wherein the switch is coupled to the first and second networks, wherein:
based on the forwarding operations in the first network and forwarding operations in the second network being based on different header fields, the circuitry is configured to apply encryption for packets received from the first network and tunnel the encrypted packets over the second network prior to forwarding the packets and
based on the forwarding operations in the first network and forwarding operations in the second network not being based on different header fields, the circuitry is configured to apply encryption for packets received from the first network prior to forwarding the packets.

17. The non-transitory computer-readable medium of claim 16, wherein the encryption comprises Media Access Control Security (MACsec).

18. The non-transitory computer-readable medium of claim 16, wherein the encryption comprises Media Access Control Security (MACsec) and wherein the tunnel the encrypted packets over the second network comprises provide security for the encrypted packets over the second network without utilization of Internet Protocol Security (IPsec).

19. The non-transitory computer-readable medium of claim 16, wherein the tunnel the encrypted packets over the second network comprises utilize a virtual private network for the encrypted packets.

20. The non-transitory computer-readable medium of claim 16, wherein the tunnel the encrypted packets over the second network comprises tunnel the encrypted packets over the second network comprises utilize a Virtual Extensible LAN (VXLAN).
